(19) United States
(12) Patent Application Publication
(10) Pub. No.: US 2003/0206623 A1
(43) Pub. Date: Nov. 6, 2003

(54) Pair gain system

(76) Inventors: Eric A. Deichstetter, Naperville, IL (US); Douglas Alan Reneker, Naperville, IL (US); Mark Alan Lassig, Naperville, IL (US); Kevin Eugene Dombkowski, Oswego, IL (US)

Correspondence Address: Werner Ulrich, 434 Maple Street, Glen Ellyn, IL, 60137, US

(21) Appl. No.: 10/140,386

(22) Filed: May 6, 2002

(51) Int. Cl. H04M 1/00; H04M 9/00

(52) U.S. Cl. 379/399.01

(57) ABSTRACT

A telecommunications pair gain system for use when all lines served by the pair gain system are within a limited distance of the pair gain system remote terminal. The distance is such that a lower voltage output from the remote terminal can be used for powering the POTS telephones. Advantageously, a single remote terminal can be used for controlling, for example, 8 POTS lines, at significantly lower expense than would be incurred using standard subscriber loop carrier technology. Advantageously, the loops no longer required for serving all of the 8 POTS lines directly, can be utilized to provide services such as Digital Subscriber Line (DSL) service to other customers without requiring the installation of additional loops between the central office and the remote terminal.

### TECHNICAL FIELD

This invention relates to telecommunications pair gain systems, and more specifically, to such systems having a remote terminal close to the served subscribers.

Problem:

In the prior art, there are many types of pair gain systems. The object of a pair gain system is to permit a relatively small number of copper pairs to serve a larger number of telephone customers. While there have been some frequency division analog systems, the bulk of the modern pair gain systems are digital, and use some form of digital carrier system to carry voice signals between a telephone central office and a remote terminal. The remote terminal then serves a number of customers much larger than the number of copper pairs, connecting a central office to a remote terminal. The subscriber loop carrier systems manufactured by Lucent Technologies Inc., are examples of these pair gain systems. A problem with the presently available pair gain systems is that they are expensive and usually prove to be economically feasible only if they can serve a relatively large number of subscribers, typically in excess of 50. At the same time, there is frequently an un-met need for a pair gain system that can serve a much smaller number of subscribers economically as a way of freeing existing copper pairs for providing special services, such as digital subscriber lines. Such digital subscriber lines cannot be conveniently served by a pair gain system, since they need the full band width made available by a copper pair.

Solution:

Applicants have studied this problem, and have recognized that the powering system of present technology subscriber loop carrier systems, requiring power generating equipment at the remote terminal, is expensive. Such powering systems may include a generator or connection to a local power company, rectifiers, and battery back-up. In many cases, a system which can only serve customers that are relatively close to a remote terminal, and can serve a small number of such customers, can be powered from the central office without requiring separate power generating equipment at the remote terminal. Such systems can be used to recapture a part of the outside plant and make it available for such special services, such as Digital Subscriber Lines (DSLs). Accordingly, Applicants have made a contribution over the prior art in accordance with their system, powered from the central office, in which a relatively small remote terminal, called a POTS Pair Multiplexer (PPM), is connected by a loop to the central office that can be relatively long, (for example, up to 12 kilofeet), but that is connected to the individual customer stations by relatively short loops, (for example, limited to one kilofoot). The restriction that the remote terminal be within a relatively short distance of the remote terminal allows major economies to be effective in the remote terminal, (i.e., the PPM), because a lower voltage powering signal can be used to power the POTS telephones, thus allowing power supplied by the central office to be used at the remote terminal. An interface between the PPM and the customer station can be implemented using an existing inexpensive integrated circuit chip, such as the Subscriber Loop Interface Circuit 7585, manufactured by Agere Systems. Further, by limiting the number of stations that can be served from the remote terminal, it is possible to supply a power feed over the copper pair connecting the central office to the remote terminal, and thus avoid the expense of generating power at the remote terminal. Advantageously, such a system, using a remote line card instead of a remote terminal, has much lower costs than a remote terminal of a subscriber loop carrier system; the system is therefore economical for small numbers of customers clustered around a PPM.

In accordance with one preferred embodiment of Applicant's invention, the carrier connection between the central office and the PPM has dedicated channels for each of the customer served by the PPM. Because the number of such customers is limited, for example, to 8 customers, Symmetric Digital Subscriber Line (SDSL) technology can be used to serve the customers. Each customer is provided with dedicated channels of the SDSL, using piece parts that are commercially available with present technology, to carry their voice signals.

In accordance with one preferred embodiment, a second pair connects the central office to the remote terminal. This second pair is used to provide metallic test access as is required by many telephone companies, and according to International Standards GR-818. Advantageously, this metallic access pair can be used as a back-up pair in case the primary pair becomes defective or is cut, and can be used to provide additional power to the PPM for trickle charging a battery in the internal power supply of the PPM.

Using this technology, only two loops are required to serve eight customers, thus leaving six loops available for providing advanced services such as Digital Subscriber Line (DSL) service.

### BRIEF DESCRIPTION OF THE DRAWING(s)

FIG. 1 is a block diagram illustrating the relationship between a central office, a PPM, and customer stations;

FIG. 2 is a block diagram of the PPM; and

FIG. 3 is a flow diagram illustrating the operation of Applicant's invention.

### DETAILED DESCRIPTION

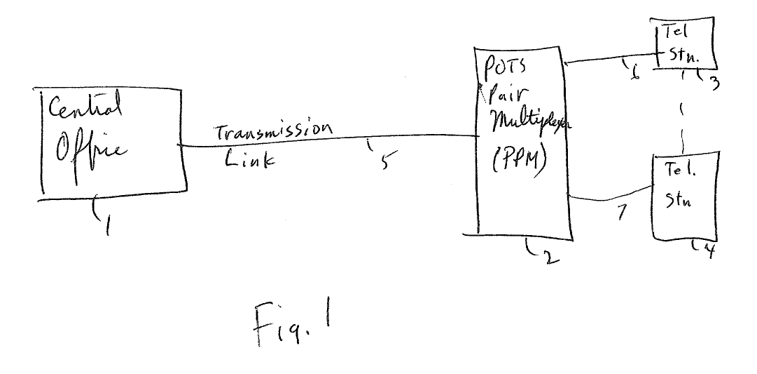

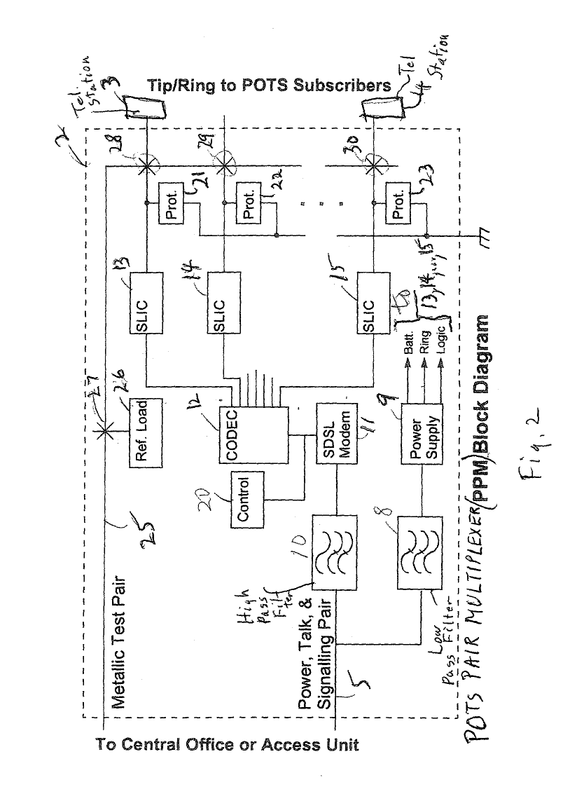

FIG. 1 illustrates the relationship between central office, the PPM, and customer stations. A Central Office (1) is connected by a transmission link (5), limited to about 12 kilofeet to the PPM (2). The PPM, in turn, is connected to customer stations (3), . . . , (4), limited in this preferred embodiment to 8 stations. The central office may contain a new interface, i.e., a new circuit pack in the line unit, with the transmission link, or the transmission link may be directly integrated into a digital switching network at the central office. The latter arrangement is the preferred arrangement for most subscriber loop carrier applications. The transmission link is a two megabit link, (1 megabit in each direction), for carrying eight 64 kilobit channels in each direction. While the bandwidth is enough to serve 16 lines, the limitations of power transmission and capabilities of DSP units make an 8 line limit preferred at this time. The PPM (2) is connected to the stations by loops (6), . . . , (7), each of which is limited to one kilofoot in length. The reason for the limitation is to allow for a simplified subscriber loop interface circuit (SLIC), such as the circuit (13), shown in FIG. 2, to act as an interface between the PPM and a customer station. A SLIC (Subscriber Line Interface Circuit) 8575, manufactured by Agere Corporation, is a relatively inexpensive circuit, and substantial savings are made possible by transmitting power from the central office instead of requiring that power be generated locally at the remote terminal. An objective is to provide service to other customers over the loops made available by the use of the pair gain system.

FIG. 2 is a block diagram of the PPM. The transmission link (5) is connected to a high-pass filter (10) and a low-pass filter (8). The low-pass filter is connected to a power supply (9). This power supply provides battery feed for the SLICs (13), . . . , (14), . . . , (15), which are connected to the customer telephone stations. The power supply (9), under the control of control system (20), also supplies ringing to a SLIC when the corresponding telephone station is to have a ringing signal applied, and supplies power to the POTS Pair Multiplexer (PPM) circuits.

The PPM is controlled by control (20), a microprocessor with connections to the SLICs (13), . . . , (14), . . . , (15), and the modem (11). The control receives signals from the SLICs, Codec and SDSL modem, indicating the supervisory state (off-hook or on-hook) of the telephone instruments connected to the SLICs, and is connected to modem (11), to receive and transmit signaling messages to the central office over a ninth time-slot of each frame. The received signaling messages are used to control the application of a ringing signal on the appropriate SLIC, and to pass on to the central office, origination requests, answer signals, and numbers dialed on dial telephones.

The high-pass filter (10) is connected to an SDSL (Symmetric Digital Subscriber Line) modem (11). The modem interfaces with a Codec function (12), in a Digital Signal Processor (DSP), which is connected to SLICs (13), . . . , (14), . . . , (15). The Codec function (12) converts digital signals received from transmission link (5) via high-pass circuit (10), and modem (11), into analog signals for transmission to each of the 8 SLICs. The modem modulates the signal from a digital stream to a digital stream on a carrier. (In effect, the 0's and 1's are now encoded on a 2B1Q or 16 QAM signal). The control (20) which receives signals from modem (11), and Codec (12), performs a number of functions. If a customer goes off-hook, the SLIC recognizes this condition, and passes a signal via Codec (12) to the control (20). Similarly, the control (20) receives on-hook signals. The control (20) also receives signals from the central office requesting that a ringing signal be applied to a particular customer, and passes the ringing signal application signal to the appropriate one of the SLICs. To save power, ringing is only applied when the control requests this. The control system also receives an indication from the SLIC and Codec of a change to off-hook, so that the ringing signal is removed. Finally, for cases in which the customer station uses dial pulse signaling, because of the difficulty of transmitting dial pulses to a central office over a transmission facility such as (5), these dial pulses are recognized and counted by control (20), which applies signaling information to the modem (11) for transmission to the central office. (For the case of customers having a Dual-Tone Multi-Frequency (DTMF) station, the digits are recognized in the central office.) Off-hook and on-hook signals are sent via the A-bit from the SLIC.

Each of the SLICs (13), (14), . . . , (15), is connected via a protection circuit (21), (22), . . . , (23), respectively, to ground. This protection circuit performs lightning protection and power cross protection.

In order to test each of the lines connected to the PPM, a metallic test pair (25) is connected to the central office is provided in order to provide metallic access. This tester can be connected under the control of control (20) in response to signals from the central office to a reference load (26), which having a standard impedance can be used by the measuring equipment in the central office to measure the impedance between the central office and the PPM. A metallic test pair can also be connected to any of the lines connecting the PPM to a customer station, and can be connected either toward the customer station, or toward the SLIC serving that customer station.

In addition, the metallic test pair (25) can be substituted for transmission facility (5) by sending a signal over the metallic test pair to control (20); this signal will cause control (20) to disconnect transmission facility (5), and substitute metallic test pair (25). In addition, metallic test pair (25) could be used to provide charging current for power supply (9), but the added cost of controlling a switch to the filter inputs, and to isolate the metallic test pair from line voltages may well be sufficiently high to make this option undesirable.

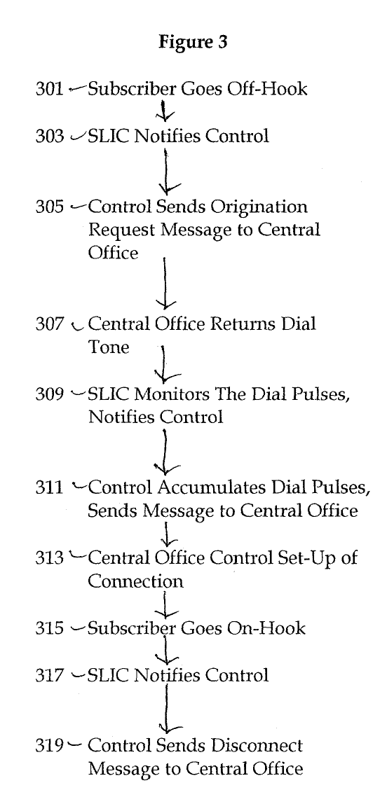

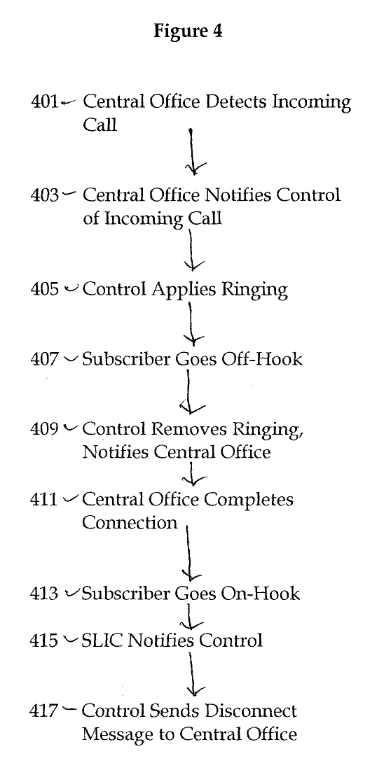

FIG. 3 illustrates an outgoing call or a call originated by a local subscriber, and terminating to another subscriber in the same central office. The local subscriber goes off-hook, Action Block (301). The SLIC notifies the control, Action Block (303). The control sends an origination request message, an “A” bit from the appropriate SLIC output, to the central office, Action Block (305). Signaling messages are sent over a separate 64 Kbit channel. The central office returns dial tone to the subscriber, Action Block (307). The SLIC monitors for dial pulses, and if it detects them, notifies the control, Action Block (309). The control accumulates the dial pulses, and sends a message to the central office, Action Block (311). Note that if the subscriber has a Dual-Tone Multi-Frequency (DTMF), Action Blocks (309) and (311) are by-passed, and the central office itself accumulates the subscriber signals. Once that is complete is complete, the central office controls the set-up of the connection, Action Block (313). Subsequently, when the conversation is complete, the subscriber goes on-hook, Action Block (315). The SLIC notifies the control of the on-hook signal, Action Block (317). The control then sends a disconnect message to the central office, Action Block (319), which disconnects the connection.

FIG. 4 illustrates the actions performed from incoming calls. The central office detects the incoming call, Action Block (401). Assuming that the called party is idle, the central office notifies the control of the incoming call, Action Block (403). (If the called customer is busy, and does not have call-waiting, the central office simply returns busy tones to the caller without performing any actions for the called subscriber. If the called subscriber has call-waiting, then the central office imposes call-waiting tone on the connection to the called subscriber. If the called subscriber subsequently flashes, then a connection is established between the waiting call and the called customer.) Continuing the normal incoming call case, the control applies ringing to the called customer, Action Block (405). If a subscriber goes off-hook, Action Block (407), then the control removes ringing, and notifies the central office, Action Block (409). The central office then completes the connection of the incoming call to the transmission channel dedicated to the called customer, Action Block (411). Subsequently, the called subscriber goes on-hook, Action Block (413), the SLIC notifies the control, Action Block (415), and the control sends a disconnect message to the central office which disconnects the incoming call connection.

The above description is of one preferred embodiment of Applicants' invention. Other embodiments will be apparent to those of ordinary skill in the art without departing from the scope of the invention. The invention is limited only by the attached claims.

1. A telecommunications pair gain system comprising a POTS (Plain Old Telephone Service) Pair Multiplexer (PPM), said PPM comprising:
a plurality of Subscriber Loop Interface Circuits (SLICs), each for connection to one POTS telephone via a loop limited to the length supported by said SLIC;
a Codec implemented on a Digital Signal Processor (DSP) for connection to said plurality of SLICs; and
a modem connected to said Codec for interfacing with a digital transmission system for connection to a central office;
wherein said plurality of SLICs is powered from a single power feed powered from the central office, for driving a lower voltage POTS telephone powering output, because of the loop length limitation.

2. The telecommunications Pair Gain System of claim 1, wherein said PPM is connected to a serving central office by a first loop to supply power and to transmit voice and signaling signals between said PPM and said central office; wherein said PPM is further connected to said central office by a metallic test pair for providing metallic test access to lines served by said PPM.

3. The telecommunications pair gain system of claim 2, wherein said metallic test pair can be substituted for said power talk and signaling power in case of a failure of said power talk and signaling power.

4. The telecommunications pair gain system of claim 1, wherein said PPM comprises a Low-Pass Filter for driving a power supply of said PPM; and
a high pass filter for communicating with said plurality of SLICs.

5. The apparatus of claim 1, wherein each of the plurality of POTS telephones served by said PPM was originally directly connected to said central office by its own loop; and
wherein the loops made available through the use of said PPM are made available for applications such as Digital Subscriber Line (DSL) service. [I feel a little queasy about this claim. It seems to me that it is obvious that whenever you have a pair gain system, you can use it for that purpose. Am I missing something?]
